(19) United States
(12) Patent Application Publication
(10) Pub. No.: US 2009/0232036 A1
(43) Pub. Date: Sep. 17, 2009

(54) Allocating radio resources to reduce the transmission power of a terminal

(75) Inventor: Francois Marx, Paris (FR)

Correspondence Address: MCKENNA LONG & ALDRIDGE LLP, 1900 K STREET, NW, WASHINGTON, DC, 20006, US

(73) Assignee: France Telecom, Paris (FR)

(21) Appl. No.: 11/989,594

(22) PCT Filed: Jul. 25, 2006
(86) PCT No.: PCT/FR2006/001813

§ 371 Date: Jan. 29, 2008

(30) Foreign Application Priority Data
Jul. 29, 2005 (FR) 0508158

(51) Int. Cl. H04W 4/00; H04W 72/00; H04B 7/00

(52) U.S. Cl. 370/311; 455/452.1; 455/522; 370/329; 455/574

(57) ABSTRACT

The invention concerns a mobile telecommunication network comprising a plurality of terminals and an allocating entity adapted to allocate radio resources. One radio resource is associated with a transmission power. One terminal of the network is selected (21) based on at least one transmission power respectively associated with at least one radio resource previously allocated to the selected terminal. Thereafter, an available radio resource is allocated (22) to the selected terminal. Then, a transmission power is associated (23) with the radio resources previously allocated to the selected terminal, so as to reduce the total transmission power allocated to the selected terminal. The previous steps are repeated (24) as long as at least one available radio resource fulfills an allocation condition.

The present invention relates to a system for allocating radio resources in a mobile telecommunication network comprising a plurality of mobile terminals.

In such networks, the terminals are provided with batteries which afford them their own energy reserve over longer or shorter time periods depending on the use which is made of the terminal or else depending on the characteristics of the battery itself. It should be noted that the energy reserve of a terminal is an important characteristic in the context of mobile telecommunication networks.

A mobile terminal consumes energy for its local management such as, in particular, the management of its screen. It also consumes energy when it transmits data on radio channels of the mobile telecommunication network.

The quantity of energy consumed by a terminal for the transmission of data may depend in particular on the conditions under which this transmission is carried out, and more precisely on the quality of the radio channels which have been allocated to this terminal. Specifically, in general, a terminal transmitting on radio channels exhibiting low-quality transmission characteristics transmits at a higher power than a terminal transmitting on radio channels exhibiting transmission characteristics of better quality. It is therefore noted that the more unfavorable the transmission conditions of a mobile terminal, the more energy the terminal consumes and the faster its energy reserve is depleted.

The quantity of energy consumed by a terminal may also depend on the throughput of the data transmission. Thus, on substantially similar quality radio channels, a transmission performed at a high throughput requires a greater quantity of energy than a transmission performed at a lower throughput. Now, in mobile networks, increasingly high transmission throughputs are offered, thereby involving, for the terminals of such networks, increasingly significant energy consumption and therefore faster depletion of their energy reserve.

It therefore appears to be very beneficial to be able to reduce a terminal's data-transmission-related energy consumption, so as to increase the energy reserve of this terminal.

The present invention is aimed at proposing a solution meeting these criteria.

A first aspect of the present invention proposes a method for allocating radio resources in a mobile telecommunication network comprising a plurality of mobile terminals;

the method comprising the following steps:

/a/ selecting a terminal from the network as a function of at least one transmission power respectively associated with at least one radio resource previously allocated to said terminal;

/b/ allocating a radio resource available to the selected terminal;

/c/ associating a transmission power with radio resources previously allocated to the selected terminal, so as to reduce the total transmission power of the selected terminal;

/d/ repeating steps /a/ to /d/ so long as at least one radio resource satisfies an allocation condition.

In the context of the present description, the association of a transmission power and of a radio resource allocated to a terminal indicates to the terminal the power level at which it must transmit on the radio resource considered.

By virtue of these arrangements, the radio resources available are allocated by priority to the terminals of the network which do not satisfy defined transmission criteria. For this purpose, when a terminal does not fulfill defined transmission criteria, after having allocated it a radio resource, a transmission power is associated with each of the radio resources of the terminal so as to reduce the total transmission power of the terminal, that is to say the sum of the transmission powers over all the radio resources at its disposal. The person skilled in the art has at his disposal a certain number of algorithms which are aimed at optimizing the total transmission power of a terminal as a function of the various radio resources at its disposal for transmitting its data. These algorithms make it possible to determine the transmission powers respectively on the allocated radio resources.

In particular, a document by David Tse and Pramond Viswanath ‘Fundamentals of Wireless Communication’, Cambridge University Press, 2005, which proposes such an algorithm referenced ‘water-filling’, is known.

The present invention covers all the algorithms which apply in such a context and which make it possible to optimize the energy consumption of a terminal by advantageously distributing the transmission powers over radio resources previously allocated to the terminal.

Then, the transmission powers thus determined are respectively associated with the radio resources allocated.

In step /d/, a repeat of the previous steps is decided as a function of the radio resources still available and capable of being allocated. To take this decision, in an embodiment of the present invention, a check is carried out to verify whether at least one radio resource capable of being allocated satisfies an allocation condition. Advantageously, it can for example be considered that a radio resource satisfies such an allocation condition when this radio resource exhibits beneficial transmission characteristics, in particular a high transmission gain, for at least one of the terminals. It is easy to deduce from this example other advantageous applications relating to the allocation condition that a radio resource to be allocated satisfies.

In an embodiment of the present invention, a radio resource satisfies an allocation condition as soon as it is available. Such a method is then aimed at allocating all the available radio resources.

When the defined transmission criteria are fulfilled for the terminals of the network, radio resources still available can then be allocated to certain terminals by taking into account transmission powers respectively associated with the already allocated radio resources.

By thus taking account of the transmission powers of the terminals when allocating additional radio resources, the terminals which are in conditions of relatively significant energy consumption can then be determined. This significant energy consumption can be in particular due to difficult transmission conditions. In such a context, these terminals can then be favored by selecting them so as to allocate them additional radio resources and allow them to improve their transmission conditions. Thus, the energy consumption of such terminals can be reduced.

It is possible to select a terminal of the network as a function of at least one transmission power associated with at least one radio resource previously allocated to this terminal according to various procedures. Thus, it is possible for example to take into account a sum of the transmission powers respectively associated with all or some of the radio resources previously allocated to the terminal.

Such a sum can be calculated simply by adding up the various values of these transmission powers. It can also be calculated according to an equation making it possible to weight these various power values. For this purpose, an equation of the type of the following equation can be used:

F(x)=(1+x^{-1/s})^{-s}

where s is a positive value, lying for example between 0 and 1.

In an embodiment of the present invention, in step /a/, a terminal not satisfying defined transmission criteria is selected by priority. Thus, a terminal is selected as a function of at least one transmission power associated with a previously allocated radio resource only if all the terminals of the network satisfy defined transmission criteria.

In an embodiment of the present invention, before step /a/, a gain value associated with each radio resource available for each terminal of the network is determined, and following which, in step /b/, the radio resource exhibiting the highest gain value for this terminal is allocated to the selected terminal.

In this way, the most efficacious radio resource for this terminal is allocated to the selected terminal.

In step /c/, for the selected terminal, a value indicating a reduction in total transmission power related to the allocation of the radio resource allocated in the previous step /b/ is determined and, if this value is less than a determined value, step /d/is carried out on the terminals of the network with the exception of the selected terminal. Thus, advantageously, a method according to the present invention is applied to the terminals for which it is determined that the allocation of an additional radio resource makes it possible to significantly reduce the total transmission power of the terminal. On the other hand, if it is estimated that the total transmission power of a terminal is scarcely able to be reduced by the allocation of a new radio resource, this terminal is excluded from the set of terminals that is considered in step /a/. Preferably, such a reduction in total transmission power is determined, in relation to a given terminal, by subtracting, from the total transmission power obtained at the previous iteration of step /c/ for this terminal, the total transmission power obtained in the current step /c/, for this same terminal.

In step /a/, a terminal, which additionally satisfies the defined transmission criteria, can be selected as a function, furthermore, of a value indicating a quantity of energy available in the terminals. In this case, this value indicating a quantity of energy available in the battery of the mobile terminals of the network is at the disposal of the allocation entity. It can allocate an additional radio resource by selecting a terminal on the basis, on the one hand, of the transmission powers respectively determined for the radio resources which are allocated to it, and, on the other hand, of the state of its battery. Thus, it is possible to favor the transmission conditions of a terminal when its battery is considered to be low.

More precisely, in an embodiment of the present invention, the selection of a terminal is carried out as a function of the transmission powers in step /a/, by implementing the following steps:
for each terminal:
   calculating a sum of the transmission powers associated with the radio resources allocated to said terminal;
   multiplying by a determined time period and obtaining a value indicating an energy consumption; and
   subtracting said value indicating an energy consumption from the value indicating a quantity of energy available in the terminals;
selecting the terminal for which in the previous step the lowest result is obtained.

In this case, preferably, the time period over which the value indicating an energy consumption is determined corresponds substantially to a time period during which the radio resources are allocated to a terminal.

In another variant, in step /a/, the selection is carried out as a function of transmission powers according to the following steps:
calculating, for each terminal, a sum of the transmission powers over the radio resources allocated to said terminal;
selecting the terminal for which the largest value is obtained in the previous step.

In an embodiment of the present invention, in step /a/, the defined transmission criteria are fulfilled for a terminal when the allocated radio resources allow said terminal to transmit at a given transmission throughput and at a total transmission power that is less than a given value.

A second aspect of the present invention proposes a base station in a mobile telecommunication network comprising a plurality of terminals.

The base station is adapted for allocating radio resources to said terminals so as to reduce the total transmission power of a terminal from among the plurality of terminals, allocated radio resources being associated with a transmission power. It comprises:
terminal selection means adapted for selecting a terminal from the network as a function of at least one transmission power respectively associated with at least one radio resource previously allocated to said terminal;
allocation means adapted for allocating a radio resource available to the selected terminal;
association means adapted for associating a transmission power of the selected terminal with radio resources previously allocated to said terminal, so as to reduce the total transmission power of the selected terminal;
control means adapted for controlling said selection means, said allocation means and said determination means.

In an embodiment of the invention, the selection means are adapted for, if at least one terminal does not satisfy defined transmission criteria, selecting said terminal.

In an embodiment of the present invention, the base station furthermore comprises interface means adapted for receiving from a terminal of the network a message comprising a value indicating a quantity of energy available in said terminal.

A third aspect of the present invention proposes a device for allocating radio resources in a mobile telecommunication network comprising a plurality of terminals. This device is adapted for allocating radio resources to said terminals so as to reduce the total transmission power of a terminal from among the plurality of terminals, a transmission power being associated with an allocated radio resource.

It comprises:
terminal selection means adapted for selecting a terminal from the network as a function of at least one transmission power respectively associated with at least one radio resource previously allocated to said terminal;
allocation means adapted for allocating a radio resource available to the selected terminal;
association means adapted for associating a transmission power of the selected terminal with radio resources previously allocated to said terminal, so as to reduce the total transmission power of the selected terminal;
control means adapted for controlling said selection means, said allocation means and said determination means.

A fourth aspect of the present invention proposes a terminal comprising:
means for providing a quantity of energy;
means for receiving an identifier of an allocated radio resource, said radio resource being allocated to said terminal as a function of at least one transmission power respectively associated with at least one radio resource previously allocated to said terminal; and
means for cooperating with an allocation entity comprising:
terminal selection means (301) adapted for selecting a terminal from the network as a function of at least one transmission power respectively associated with at least one radio resource allocated to said terminal;
allocation means (302) adapted for allocating a radio resource available to the selected terminal;
association means (303) adapted for associating a transmission power of the selected terminal with radio resources previously allocated to said terminal, so as to reduce the total transmission power of the selected terminal;
control means (304) adapted for controlling said selection means, said allocation means and said determination means.

In an embodiment of the present invention, the terminal comprises interface means adapted for dispatching a message to the allocation entity, said message comprising a value indicating a quantity of energy available in said terminal.

A fifth aspect of the present invention proposes a system for allocating radio resources comprising a base station according to the second aspect of the present invention and a plurality of terminals according to the third aspect of the present invention.

A sixth aspect of the present invention proposes a computer program intended to be installed in a base station, comprising instructions able to implement the method according to the first aspect of the present invention, during an execution of the program by processing means of the base station.

A seventh aspect of the present invention proposes a computer program intended to be installed in a terminal, comprising instructions able to implement the method according to the first aspect of the present invention, during an execution of the program by processing means of the terminal.

Other aspects, aims and advantages of the invention will be apparent on reading the description of one of its embodiments.

The invention will also be better understood with the aid of the drawings, in which:

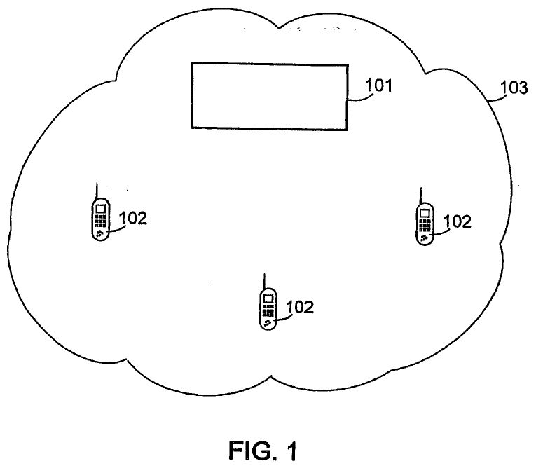

FIG. 1 illustrates a telecommunication network according to an embodiment of the present invention;

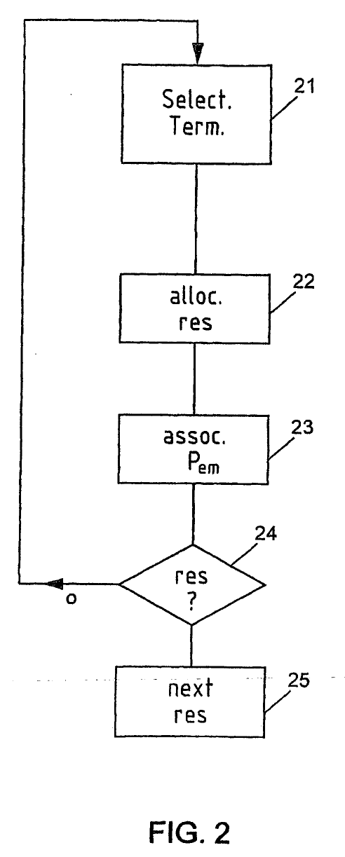

FIG. 2 illustrates the main steps of a method according to an embodiment of the present invention;

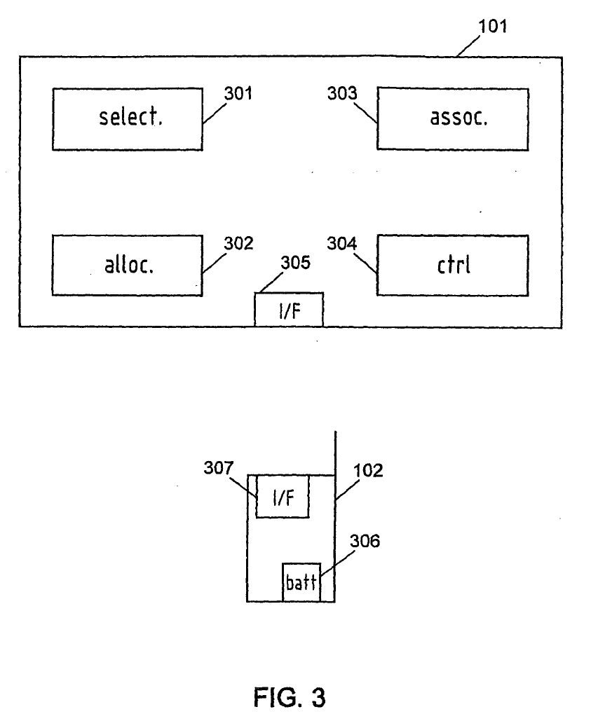

FIG. 3 illustrates a base station and a terminal according to an embodiment of the present invention.

The invention is described hereinafter in its application to the multi-user systems with several transmission channels, such as for example systems of OFDM type for “Orthogonal Frequency Division Multiplexing”. Thus, subsequently, the radio resources allocated in the system of OFDM type are OFDM subcarriers.

This description is not limiting and it should be noted that the present invention can find a simple and effective application in any other type of mobile telecommunication network.

FIG. 1 illustrates a mobile telecommunication network comprising an entity for allocating radio resources or subcarriers 101, as well as a plurality of mobile terminals 102. In a conventional mobile telephone network, the allocation entity can be a base station 101.

FIG. 2 illustrates the main steps of a method according to an embodiment of the present invention. The base station 101 has available a set of subcarriers to be allocated to the terminals 102.

In step 21, a terminal is selected from among the terminals 102 of the network 103 so as to allocate it an available subcarrier. This step is firstly aimed at selecting a terminal which does not meet defined transmission criteria. Such transmission criteria can comprise a target throughput, that is to say a throughput expected by all the terminals of the network. They can also comprise a maximum power or a combination of these two criteria. Specifically, to protect the users of the mobile terminals or else to avoid overly large interference between terminals, certain standards fix a value of maximum total transmission power per terminal. Other transmission criteria can easily be taken into account in this selection step. It is also possible to envisage different criteria according to the type of subscription to which the user of the terminal has subscribed.

In step 21, so long as a terminal is not able to satisfy the defined transmission criteria, the base station selects it. Such is the case, in particular, when a terminal in the network has no allocated subcarrier. For example, such a terminal gets selected so long as the radio resources which are allocated to it do not allow it to transmit at the target throughput defined in the transmission criteria and at a total transmission power that is less than the value of the maximum power as defined in the transmission criteria.

When several terminals do not satisfy the defined criteria, the selection of a terminal from among them can be done in a random manner; or better, by choosing the terminal which exhibits characteristics furthest from the defined criteria.

In the case where all the terminals satisfy the transmission criteria, a terminal is selected as a function of at least one transmission power associated with the radio resources which are already allocated to it. In an embodiment of the present invention, such a selection is in fact aimed at determining which of the terminals is in the least advantageous transmission conditions, said conditions requiring therefore a significant energy consumption in relation to the other terminals in the network. For this purpose, the transmission powers which have been determined for the radio resources at the disposal of the terminal are used as a basis.

On completion of step 21, a terminal is selected.

In step 22, an available radio resource is allocated to the selected terminal. In an embodiment of the present invention, in the case where several radio resources are available, one of these radio resources is selected so as to favor the transmission conditions of the terminal. It may then be advantageous to select a radio resource as a function of a gain value corresponding to the radio resource and to the selected terminal.

For this purpose, preferably before step 21, the base station determines a gain value for each radio resource associated with each terminal of the network. Thus, the base station temporarily allocates, and more precisely for a short duration, all the radio resources available to each of the terminals of the network. During this time period, the base station determines the gain values of all the radio resources in relation to all the terminals. The person skilled in the art is aware of procedures for determining these gain values. Consequently, these procedures for estimating transmission characteristics of the channels will not be detailed in the following sections.

In this way, in step 22, the base station is then able to select the radio resource which exhibits the largest gain for the terminal selected, and to allocate this radio resource to it.

In step 23, a new configuration for distributing the transmission powers is determined on the subcarriers which are then at the disposal of the selected terminal. For this purpose, the invention covers all procedures allowing efficacious distribution of the transmission powers over the radio resources allocated to this terminal, such as in particular ‘water-filling’ algorithms as referenced above.

It is also possible to apply the steps described in the following sections.

We denote by k the terminal for which a distribution of the transmission powers is sought, that is to say the terminal to which a new subcarrier has just been allocated. The following notations are considered:
Rₖ the throughput requested by terminal k (that is to say the target throughput);
v_{k,n} the ratio of the thermal noise power spectral density, denoted N₀, to the gain of the channel corresponding to terminal k and to subcarrier n, denoted H_{k,n}, i.e. the ratio N₀/H_{k,n};
Sₖ the set of subcarriers n allocated to terminal k;
ε, δ and ρ constants;
P_{k,n} the transmission power on subcarrier n allocated to terminal k;
w a reference power value;
R a throughput.

R and w are initialized to the value 0.

Then, so long as a difference between the transmission throughput at the disposal of the terminal and the target throughput Rₖ is greater than a certain value, denoted ε, that is to say:

So long as |Rₖ−R|>ε, (1)

the following steps are carried out:
the reference power value is increased according to the equation:

w′=w+δ;
a transmission power on the subcarriers allocated to terminal k is determined according to the equation:

P_{k,n}=max(w−v_{k,n},0); for nεSₖ
the throughput corresponding to this new transmission power distribution is calculated according to the following equation:

$$R = {\sum }_{n ∈ {S}_{k}} {log}_{2} ( 1 + \frac{{P}_{k , n}}{{v}_{k , n}} ) ;$$

if the throughput thus calculated is less than the target throughput Rₖ, the following equation is applied:

w′=w;

otherwise, the value of δ is reduced according to the equation:

δ=δ/2; then we return to the equation referenced (1).

Thereafter, when the difference between the target throughput Rₖ and the calculated throughput R is less than ε, the transmission power is determined on each subcarrier n of the set Sₖ according to the following equation:

P_{k,n}=max(w′−v_{k,n},0).

Then, advantageously, in an embodiment of the present invention, the reduction in total transmission power obtained by allocating the additional subcarrier is determined. If this reduction is considered to be small, the total transmission power of this terminal is considered to be probably no longer capable of being reduced appreciably by allocating additional subcarriers. The reduction in total transmission power, less than ρ, from which terminal k has benefited after the allocation of a new subcarrier is considered not to justify the possibility that this terminal may again benefit from an additional subcarrier allocation.

Therefore, this terminal k is excluded from the set of terminals considered in step 21. The set of terminals considered in step 21 is denoted T subsequently.

This condition can be written in the following manner:

$$If$$

$$\vert {\sum }_{n ∈ {S}_{k}} {P}_{k , n} - max ( {w}^{′} - {v}_{k , n} , 0 ) \vert < ρ$$

$$then$$

$$T = T ⋂ \overline{( T ⋂ \{ k \} )}$$

In step 24, if a radio resource is still available (arrow o on output from test 24), then the steps of this method are repeated. In the converse case, the base station waits for an already allocated radio resource to be released so as to be able to apply a method of allocating this radio resource according to an embodiment of the present invention.

When no available subcarrier is any longer at the disposal of the base station, it remains on standby waiting for a released subcarrier. In this case, the steps of the method 21 to 24 are executed again.

The selection of a terminal as a function of the transmission powers can be carried out according to diverse variants.

Thus, in a first variant, in step 21, the selection as a function of at least one transmission power is carried out by considering, for each terminal belonging to the set T of terminals, the sum of the transmission powers associated with all the subcarriers respectively allocated to a terminal. T comprises the terminals for which the allocation of an additional subcarrier is considered to be unable to make it possible to reduce the energy consumption.

In this case, when all the terminals of the network satisfy the defined transmission criteria, the allocation of additional subcarriers is made to the terminal which provides a total transmission power greater than that which is provided by the other terminals of the network. For this purpose, the base station can calculate for each terminal k of the network, if appropriate for each terminal k of the set T previously defined, a value Aₖ according to the following equation:

$${A}_{k} = {\sum }_{n ∈ {S}_{k}} {P}_{n , k}$$

Then, the terminal k, for which a maximum value Aₖ is obtained, is selected.

In a second variant, the selection of a terminal as a function of at least one transmission power can be carried out by taking account furthermore of the state of the battery of the terminals. In this case, preferably, the base station receives from the terminals an information cue relating to the state of the battery. This information cue indicates a quantity of energy available in the battery of each terminal.

It can be dispatched periodically from the terminals to the base station. Such an information cue does not require frequent updating. A message containing the information cue relating to the state of the battery can advantageously be dispatched with a time period of the order of a few minutes.

In an embodiment of the present invention, this information cue is included in a control frame or else in a connection request frame. It is also possible to envisage transmitting such an information cue to the base station via a message of SMS type (for ‘Short Message Service’). The invention covers all the procedures for transmitting such an information cue.

It should be noted that this information transmission from the terminals to the base station remains simple to implement and consumes little bandwidth.

The following sections describe an embodiment according to the second variant. The system considered comprises an integer number K of terminals k. The transmission criteria for a terminal referenced k correspond to a transmission throughput Rₖ as well as to a total transmission power of maximum value denoted Pₘₐₓ. The number of subcarriers in the network is denoted N and the total bandwidth of the network is denoted B.

Each subcarrier allocated to a terminal corresponds to a different radio channel whose gain is denoted H_{k,n}. Furthermore, the information cue indicating a quantity of energy available in the battery of a terminal k is denoted Eₖ.

In this variant, preferably one seeks to select the terminal which, after having transmitted data for a certain time period on the radio resources which are allocated to it, would be the one having at its disposal the smallest quantity of energy in its battery.

The base station having at its disposal, for each terminal, an information cue relating to the state of the battery and transmission powers on each allocated subcarrier, is able to estimate the state of the battery of each terminal after it has transmitted for a time period denoted Δt.

In an embodiment of the present invention, the time period Δt, over which such an energy consumption is determined, is advantageously dependent on the mean time interval during which a radio resource allocation remains valid in the network.

For example, it is possible to determine a value fixed on initializing the system, then, at regular time intervals, the changes of channels which have occurred are estimated. If the changes of channels estimated have been very significant during the last time interval considered, the time period Δt over which an energy consumption is calculated can then advantageously be reduced. On the other hand, if the changes of channels have been small, the same time period can be preserved, and if the changes of channels have been extremely small, it is even possible to envisage increasing the time period Δt.

Thus, in an embodiment of the present invention, in order to select the terminal to which an additional subcarrier will be allocated, the base station takes into account the state of the battery of the terminals of the network as well as the energy which will be consumed, during the forthcoming time period Δt, for the transmission of data on the already allocated subcarriers. Thus, the base station carries out an estimation of the quantity of energy which will be available in the battery after the transmission of data on the already allocated subcarriers during this time period.

Advantageously, the base station determines an estimation E′ₖ of the state of the battery of each terminal of the network according to the following equation:

$${E}_{k}^{′} = Ek - Δ t {\sum }_{n ∈ {S}_{k}} {P}_{n , k}$$

where Sₖ is the set of subcarriers allocated to terminal k.

Then, the base station selects the terminal for which the result obtained E′ₖ is the smallest.

A third variant can be based at one and the same time on the first variant and on the second variant, in particular in the case where certain terminals of the network do not have the capability of dispatching an information cue relating to the state of their battery to the base station.

In another variant, the terminals of the network which fulfill the defined transmission criteria and which are selected to be allocated an additional subcarrier are those which have taken out a subscription with the operator managing the network in which they are located. Thus, only the terminals which have taken out a specific subscription can benefit from an additional subcarrier enabling them to reduce their energy consumption and therefore increase their energy reserve.

On the basis of these variants relating to the implementation of step 21, it is easy for the person skilled in the art to deduce others therefrom.

FIG. 3 illustrates a base station 101 in a mobile telecommunication network comprising a plurality of terminals adapted for allocating radio resources to said terminals.

The base station comprises:
terminal selection means 301 adapted for selecting, if a terminal of the network does not satisfy defined transmission criteria, said terminal; and otherwise for selecting a terminal from the network as a function of transmission powers respectively determined for radio resources allocated to said terminal;
allocation means 302 adapted for allocating a radio resource available to the selected terminal;
determination means 303 adapted for determining a transmission power of the terminal selected on each radio resource allocated to said terminal, so as to reduce the total transmission power of the selected terminal;
control means 304 adapted for controlling said selection means, said allocation means and said determination means and implementing a method according to an embodiment of the present invention.

The base station can furthermore comprise interface means 305 adapted for receiving from a terminal of the network a message comprising a value indicating a quantity of energy available in said terminal.

FIG. 3 also illustrates a terminal in an embodiment of the present invention. This terminal is adapted for cooperating with the base station 101.

In a variant, the terminal furthermore comprises interface means 307 adapted for dispatching a message to the base station 101, this message comprising a value indicating a quantity of energy available in the mobile terminal.

An embodiment of the present invention advantageously affords the terminals in a mobile telecommunication network a greater energy reserve. Consequently, such a method can make it possible to lengthen the users' communication time in such a network. An embodiment of the present invention is easy to implement.

As set forth above, such a method also allows an operator to offer an additional service.

A system according to an embodiment of the present invention is particularly suited to terminals having relatively low mobility, such as, for example, terminals used by pedestrians.

Specifically, the less significant the channel variations as a function of time, the easier it is to implement an embodiment. The expression ‘variation of channels’ is understood to mean a change of allocation of the radio resources to the terminals. These variations may be due to the fact that the moving terminals exit the network and that others, likewise moving, enter it. This mobility gives rise to changes in the allocation of the radio resources and therefore faster or slower channel variations as a function of the mobility of the terminals.

1. A method for allocating radio resources in a telecommunication network having a plurality of terminals, the method comprising:
/a/ selecting a terminal of the network as a function of at least one transmission power associated with at least one radio resource previously allocated to said terminal;
/b/ allocating a radio resource available to the selected terminal;
/c/ associating a transmission power with radio resources previously allocated to the selected terminal;
/d/ repeating steps /a/ to /d/ so long as at least one available radio resource satisfies an allocation condition.

2. The method for allocating radio resources as claimed in claim 1, where in step /a/, if at least one terminal of the network does not satisfy defined transmission criteria, said terminal is selected.

3. The method for allocating radio resources as claimed in claim 1, where in step /c/, for the selected terminal, a value indicating a reduction in total transmission power related to the allocation of the radio resource allocated in the previous step /b/ is determined; and according to which, if said value is less than a determined value, step /d/ is carried out on the plurality of the terminals with the exception of said selected terminal.

4. The radio resource allocation method as claimed in claim 1, where in step /a/ a terminal satisfying the transmission criteria defined as a function, furthermore, of a value indicating a quantity of energy available in the terminals is selected.

5. The radio resources allocation method as claimed in claim 4, wherein selecting a terminal as a function of the transmission powers in step /a/ comprises
for each terminal:
calculating a sum of the transmission powers over the radio resources previously allocated to said terminal;
multiplying by a determined time period and obtaining a value indicating an energy consumption;
subtracting said value indicating an energy consumption from the value indicating a quantity of energy available in the terminals; and
selecting the terminal for which, in the previous step, the lowest result is obtained.

6. The radio resource allocation method as claimed in claim 1, where in step /a/, selecting a terminal as a function of transmission powers comprises:
calculating, for each terminal, a sum of the transmission powers associated with the radio resources allocated to said terminal; and
selecting the terminal for which the largest value is obtained in the previous step.

7. A radio resources allocation entity in a mobile telecommunication network having a plurality of terminals, said radio resources allocation entity being adapted for allocating radio resources to said terminals so as to reduce the total transmission power of a terminal from among the plurality of terminals, transmission power being associated with an allocated radio resource, said radio resources allocation entity comprising:
terminal selection means adapted for selecting a terminal from the network as a function of at least one transmission power associated with at least one radio resource previously allocated to said terminal;
allocation means adapted for allocating a radio resource available to the selected terminal;
association means adapted for associating a transmission power of the selected terminal with radio resources previously allocated to said terminal; and
control means adapted for controlling said selection means, said allocation means and said determination means.

8. The radio resources allocation entity as claimed in claim 7, wherein said selection means is adapted for, if at least one terminal does not satisfy defined transmission criteria, selecting said terminal.

9. The radio resources allocation entity as claimed in claim 7, further comprising interface means adapted for receiving from a terminal of the network a message comprising a value indicating a quantity of energy available in said terminal.

10. (canceled)

11. (canceled)

12. (canceled)

13. A terminal in a telecommunication network
having means for receiving an identifier of an allocated radio resource, means for dispatching a transmission power on radio resources allocated to said terminal, and means for cooperating with a radio resources allocation entity comprising:
terminal selection means adapted for selecting a terminal from the network as a function of at least one transmission power associated with at least one radio resource allocated to said terminal;
allocation means adapted for allocating a radio resource available to the selected terminal;
association means adapted for associating a transmission power of the selected terminal with radio resources previously allocated to said terminal; and
control means adapted for controlling said selection means, said allocation means and said determination means.

14. The mobile terminal as claimed in claim 13, further comprising interface means adapted for dispatching a message to the radio resources allocation entity, said message comprising a value indicating a quantity of energy available in said terminal.

15. (canceled)

16. (canceled)

17. A computer program intended to be installed in a radio resources allocation entity, said program comprising instructions able to implement the method as claimed in claim 1, during an execution of the program by processing means of the base station.

18. (canceled)

19. The radio resources allocation entity as claimed in claim 7, wherein the radio resources allocation entity is a base station.
